(19) United States
(12) Patent Application Publication
(10) Pub. No.: US 2020/0228567 A1
(43) Pub. Date: Jul. 16, 2020

(54) Detecting Shrew Attacks Using Spectral Analysis and Clustering

(71) Applicant: The Government of the United States of America, as represented by the Secretary of the Navy, Arlington, VA (US)

(72) Inventors: Myong Hoon Kang, Fairfax, VA (US); Paul Cotae, Potomac, MD (US); Alexander Velazquez, Washington, DC (US)

(21) Appl. No.: 15/789,500

(22) Filed: Oct. 20, 2017

Related U.S. Application Data
(60) Provisional application No. 62/410,952, filed on Oct. 21, 2016.

(51) Int. Cl. H04L 29/06

(52) U.S. Cl. CPC H04L 63/1458; H04L 63/1433; H04L 63/1425; H04L 63/1416

(57) ABSTRACT

Systems and method are provided for detecting Low Rate (LR) Denial of Service (DOS) Attacks, such as Shrew and New Shrew attacks, using spectral analysis and clustering algorithms. In an embodiment, the presence of suspicious low frequency periodic bursts due to Shrew or New Shrews attacks is detected during a specific time period using the aggregated traffic from multiple hosts. If low-frequency periodic bursts are suspected, clustering can be used to isolate suspicious hosts. After suspicious hosts are identified, a statistic test (e.g., a Fisher g-statistic test) for periodical content can be performed again on the traffic from each suspicious host to confirm the presence of a Shrew (New Shrew) attack and identify the offending host(s).

### CROSS REFERENCE TO RELATED APPLICATIONS

This application claims the benefit of U.S. Provisional Patent Application No. 62/410,952, filed on Oct. 21, 2016, which is incorporated by reference herein in its entirety.

### FIELD OF THE DISCLOSURE

This disclosure relates to detecting attacks on networks, including detecting Shrew attacks on networks.

### BACKGROUND

Denial of Service (DOS) attacks can be used by third parties to deny legitimate users access to particular resources on a computer network. Typical DoS flooding attacks are characterized by sustained high rate or high volume. Recently, variants of DoS (low and slow) attacks such as Shrew and New Shrew attacks, also known as low rate Transmission Control Protocol (TCP)-targeted attacks, have been identified that are even more difficult to detect. These attacks exploit the TCP's congestion control algorithm and attempt to deny the bandwidth to legitimate TCP flows by sending packets at a sufficiently low average rate in order to elude detection by counter-DoS mechanisms.

Conventional techniques to detect Shrew attacks have several drawbacks. For example, one conventional technique involves having to apply spectral analysis techniques to traffic from an individual host all the time (i.e., either there is an attack or not). If many hosts send network traffic, then the overhead could be very large. A second conventional approach tries to determine if there is an attack based on circumstantial evidence by observing disturbance of acknowledge (ACK) behavior or other traffic disturbance to determine that there must be an attack. However, disturbance of ACK behavior or other traffic disturbance can also result from normal network traffic when it is congested.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a diagram illustrating a Shrew attack in accordance with an embodiment of the present disclosure;

FIG. 1B is a diagram illustrating a second type of Shrew attack (a “New Shrew” attack) in accordance with an embodiment of the present disclosure;

FIG. 2 is a flowchart of an exemplary Shrew attack detection scheme in accordance with an embodiment of the present disclosure;

FIG. 3 is a flowchart of exemplary steps performed by Fisher g and Fisher G-tests for an exemplary Shrew attack detection scheme in accordance with an embodiment of the present disclosure;

FIGS. 4A-4C show periodogram matrix representations of data in accordance with an embodiment of the present disclosure; and

FIG. 5 is a diagram of an exemplary system for detecting Shrew attacks in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### 1. OVERVIEW

Embodiments of the present disclosure provide practical systems and methods to detect Low Rate (LR) Denial of Service (DOS) Attacks, such as Shrew and New Shrew attacks, using spectral analysis and clustering algorithms. Embodiments of the present disclosure provide more efficient detection schemes for detecting Shrew attacks than conventional techniques. Embodiments of the present disclosure can detect a potential Shrew attack in a network from one aggregate flow (e.g., by applying a Fisher g-test) and, once a Shrew attack is suspected from an aggregate flow, embodiments of the present disclosure can detect sources of the Shrew attack from multiple flows (e.g., by applying a Fisher G-test).

For example, in an embodiment, the presence of suspicious low frequency periodic bursts due to Shrew or New Shrews attacks is detected during a specific time period using the aggregated traffic from multiple hosts. In an embodiment, the Fisher g-statistic test can be used to detect low frequency periodic bursts, and aggregated traffic can be used to lower the overhead of this step. For example, the Fisher g-statistic test can be applied to a periodogram to find the periodical content of any “aggregate” flow.

If low-frequency periodic bursts are suspected, clustering can be used to isolate suspicious hosts. In an embodiment, for clustering, Growing Hierarchical Self-Organizing Maps (GHSOM) and time-series clustering algorithms can be used to isolate the suspicious hosts. After suspicious hosts are identified, a statistic test (e.g., a Fisher g-statistic test) for periodical content can be performed again on the traffic from each suspicious host to confirm the presence of a Shrew (New Shrew) attack and identify the offending host(s). In an embodiment, a spectrum analyzer can be used to obtain more information about New Shrew attack from the spectral domain in addition to information from the Fisher g-statistic test.

Conventional techniques for detecting Shrew attacks usually assume for the null hypothesis the Gaussian noise assumption. Embodiments of the present disclosure can estimate the variance (standard deviation) directly from the time series by using sample variance. Embodiments of the present disclosure make no assumption about the time duration of the periodical content embedded in the time series. In contrast to the conventional techniques that assume an attack is “continuously” in effect until the buffer is full, embodiments of the present disclosure can detect a malicious flow even when the attack is in “full-on burst mode.” Embodiments of the present disclosure do not assume that when the number of samples is large, the central limit theorem can be applied to approximate the aggregate flow by a Gaussian random variable. Embodiments of the present disclosure can detect the presence of a Shrew attack using aggregate network flow first and can provide a low-overhead detection scheme (i.e., does not have to test a Shrew attack for the traffic from an individual host all the time).

### 2. SHREW ATTACKS

The Transmission Control Protocol (TCP) operates at two time scales. Typical operations operate on a smaller time scale of round trip times (RTTs), usually 10s to 100s of milliseconds. At times of congestion when packet losses occur, TCP operates on longer timescales of retransmission time out (RTO), typically 1 to 3 seconds. A slow RTO time scale is a key source of vulnerability to low-rate attacks. A Shrew attack, which consists of periodic “on-off bursts,” can exploit the homogeneity of the TCP's RTO mechanism. For example, a Shrew attack can involve a Reduction of Quality (RoQ) attack that consists of periodic bursts with a length, period, and rate equal or greater than a bottleneck capacity of a network.

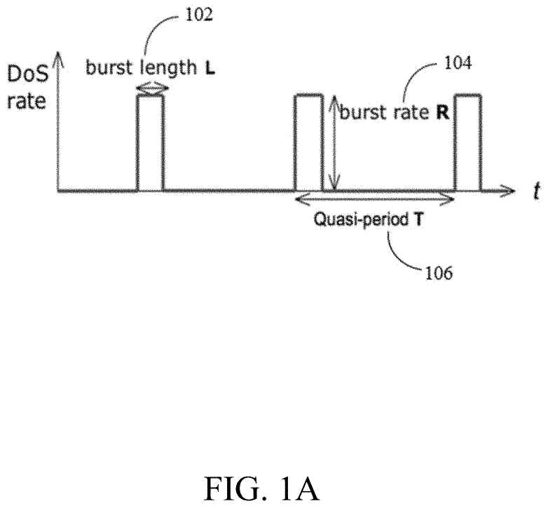

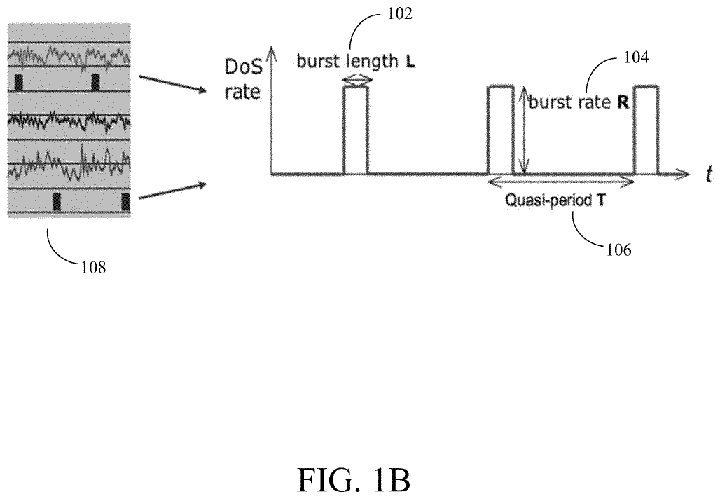

FIG. 1A is a diagram illustrating a Shrew attack in accordance with an embodiment of the present disclosure. In a time domain, a Shrew attack can be modeled by a set of three parameters {L, R, T}, as shown in FIG. 1A. In FIG. 1A, T 106 is the period of deterministic on-off pattern that is the period of the scale of the RTO. In a Shrew attack, the transmitted rate (burst rate) R 104 (e.g., in Mb/s) is large enough to induce loss, and the burst length L 102 is the duration of burst. When such burst attacks arrive at a bottleneck link, the TCP sender stops transmitting packets and enters into timeout state. After minRTO, when a valid sender attempts to retransmit its lost packets, a new round of bursts from an attacker arrives, and the sender is forced to re-enter into timeout state again. In this way, the sender is being denied a service. The frequency of typical Shrew attacks is less than 1 Hz (T≥1 second).

According to TCP, after a TCP flow exits timeout, it enters a slow start phase and exponentially recovers its transmission rate. FIG. 1B is a diagram illustrating a second type of Shrew attack (a “New Shrew” attack), that can exploit this property of TCP. The New Shrew attack represented in the time domain in FIG. 1B exploits the TCP slow-start mechanism and intentionally permits the victim to exit a timeout state to enter into slow start phase after every burst. It also has a burst behavior and persists in quasi-periodic or nearly-periodic bursts that exploit the slow-start mechanism. This attack is more powerful than a conventional Shrew attack, in the sense that the attacker can transmit at a lower rate with a higher attack efficiency than when using a conventional Shrew attack. It is much easier for an attacker using a New Shrew attack to be “masked” by the background traffic in a time domain (e.g., by changing attack parameters), which is the usual avenue of avoiding detection by DoS attack defense mechanisms.

It is not difficult to devise a distributed New Shrew to evade detection. In this kind of attack, multiple attack hosts (e.g., a botnet) create the effect of a New Shrew attack, as illustrated by the graph 108 in FIG. 1B. All variants of Shrew attacks (e.g., a Shrew (i.e., “classic” Shrew), New Shrew, Distributed New Shrew, etc.) can be referred to as Shrew attacks. Embodiments of the present disclosure provide systems and methods for identifying all Shrew attacks (e.g., Shrew, New Shrew, Distributed New Shrew, etc.).

### 3. DETECTING SHREW ATTACKS

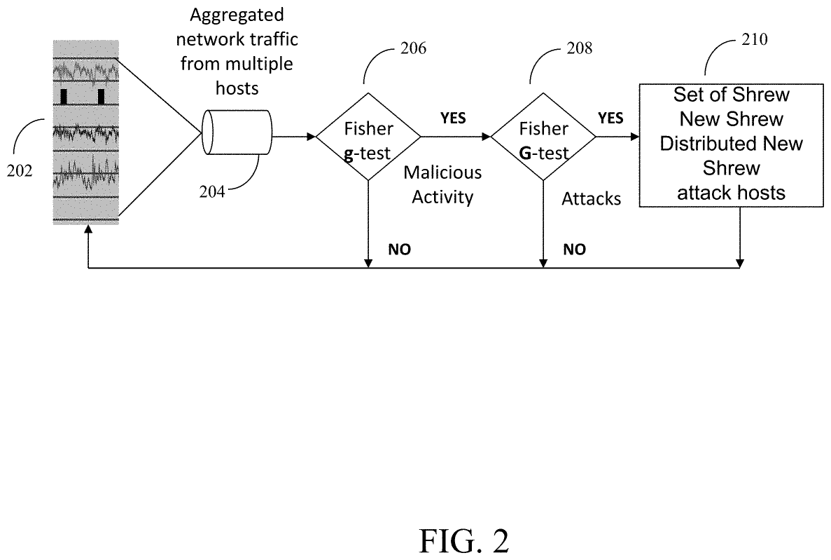

FIG. 2 is a flowchart of an exemplary Shrew attack detection scheme in accordance with an embodiment of the present disclosure. In FIG. 2, traffic 202 from multiple hosts is aggregated (e.g., by a router and put into a central repository 204, such as a network server). In an embodiment, an application or device (e.g., a monitor and/or controller application or device) at the central repository 204 can analyze traffic as it is aggregated. Once the traffic is aggregated, two Fisher tests can be performed on the traffic. Specifically, in an embodiment, a Fisher g-test 206 can be performed on the traffic to detect a potential Shrew attack on the system. If the Fisher g-test 206 determines that the aggregated traffic does not contain a potential Shrew attack, traffic can continue to be aggregated and analyzed at central repository 204 until the Fisher g-test 206 detects the presence of a potential Shrew attack in the aggregated traffic.

In an embodiment, if the Fisher g-test 206 determines that there is a potential Shrew attack, a Fisher G-test 208 can be performed on the aggregated traffic to identify all Shrew attacks and attackers in the aggregated traffic (including Shrew, New Shrew, and/or Distributed New Shrew attacks). If the Fisher g-test 206 mistakenly detected the presence of a Shrew attack, the Fisher G-test 208 can determine that a “false alarm” was generated by the Fisher g-test 206, and traffic can continue to be aggregated and analyzed at central repository 204 until the Fisher g-test 206 detects the presence of a potential Shrew attack in the aggregated traffic. In an embodiment, if the Fisher G-test 208 detects the presence of a Shrew attack in the aggregated traffic, then the Fisher G-test 208 outputs identities of Shrew attack host(s) (including Shrew, New Shrew, and/or Distributed New Shrew attack host(s)).

In an embodiment, the Fisher G-test can send a notification (e.g., to a controller, such as a controller executing at central repository 204 and/or to another device, application, and/or user) of the identified Shrew attack host(s). In an embodiment, a notified device, application, and/or user can take action to mitigate the Shrew attack(s), such as by blocking traffic (and/or access to the notified device) from the identified host(s) and/or sending a message to another device (e.g., a router) to block traffic from the identified host(s) (and/or access to the notified device). In an embodiment, traffic can continue to be aggregated and monitored at central repository 204 after (or while) Fisher G-test 208 (and/or Fisher g-test 206) has identified the Shrew attack host(s).

In an embodiment, the Fisher g statistic test 206 accepts as an input only one time series that is the aggregated network traffic flow from multiple hosts (system) while the Fisher G statistics test 208 accepts as input multiple time series coming from all hosts (in the system), and its action is validated only if there is malicious activity in the system. In an embodiment, the first step for detecting a Shrew attack is to detect the presence of low periodic bursts due to Shrew, New Shrew, or Distributed Shrew attacks during a specific time period using the aggregated traffic from multiple hosts.

In an embodiment, the role and use of the Fisher g-test 206 is the detection of malicious activity in the system during the time period that the input is collected. In an embodiment, if there is no malicious or suspicious activity in the system, then the output of Fisher g-test 206 is NO, a new aggregated network traffic flow for the next time period from multiple hosts is collected, and the detection process is repeated. In an embodiment, if there is a malicious activity detected in the system then the output of Fisher g-test 206 is YES, and multiple time series from multiple hosts are tested with Fisher G statistics test 208.

In an embodiment, the role and use of the Fisher G-test 208 is to identify all the Shrew attacks in the system (Shrew, New Shrew, or Distributed New Shrew). In an embodiment, after identifying all the Shrew attacks, the Fisher G-test 208 can send a message that there are NO more attacks in the system and a new aggregated network traffic flow from multiple hosts can be applied to the input of Fisher g-test 206. In an embodiment, if there is a “false alarm” from the Fisher g statistic test 206, then this “false alarm” will be detected by the Fisher G statistics test 208.

### 4. EXEMPLARY STEPS FOR FISHER G-TESTS AND FISHER G-TESTS TO DETECT SHREW ATTACKS

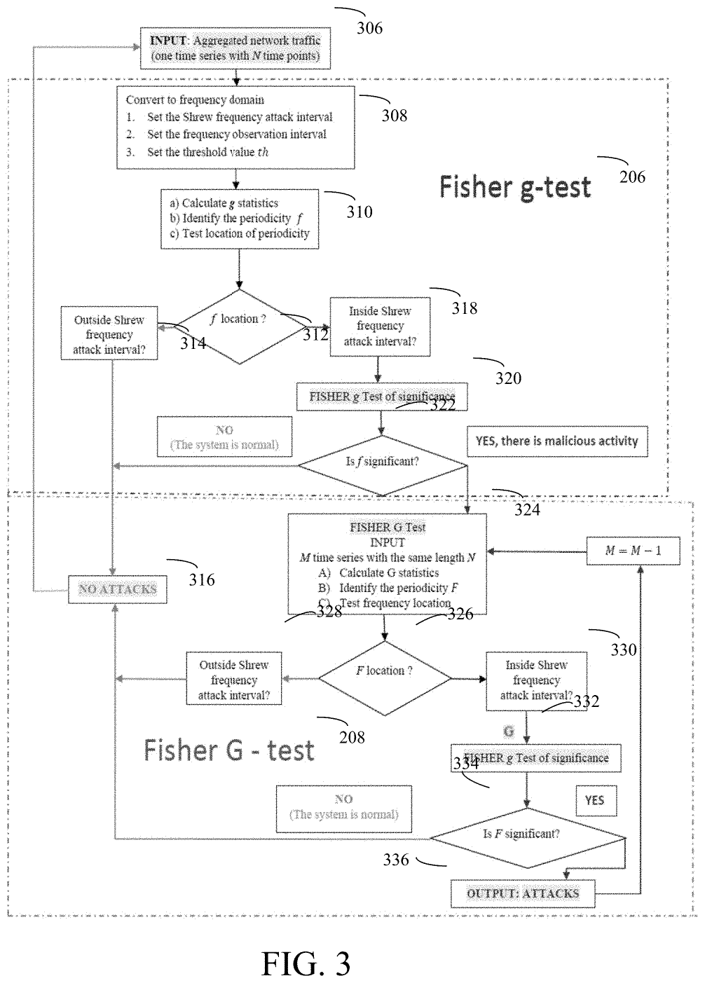

FIG. 3 is a flowchart of exemplary steps performed by Fisher g 206 and Fisher G 208 tests for an exemplary Shrew attack detection scheme in accordance with an embodiment of the present disclosure. As shown by the dotted boxes in FIG. 3, in an embodiment, some steps are performed by Fisher g-test 206, and some steps are performed by Fisher G-test 208. In FIG. 3, Fisher g-statistics can be applied to one flow to detect malicious activity in the system, while the Fisher G-statistics can be applied to multiple flows to detect Shrew attacker hosts. In an embodiment, at the input 306 of the Fisher g-test 206, one time series is applied, which represents the aggregated network traffic from multiple hosts. At the output 336 of the Fisher G-test 208, we will obtain the identified set of Shrew, New Shrew and Distributed New Shrew attack hosts, if any.

In step 306, input 306 from aggregated network traffic is received. For example, in an embodiment, traffic 202 from multiple hosts is aggregated (e.g., into a central repository 204, such as a network server). In an embodiment, a device or application at central repository 204 analyzes and or monitors the traffic (e.g., using Fisher g-test 206 and Fisher G-test 208). For example, in an embodiment, central repository 204 can first perform a Fisher g-test 206 on the aggregated traffic.

In FIG. 3, the first step of Fisher g-test 206 is step 308. In step 308 (explained in greater detail below), aggregated network traffic is converted to frequency domain, and a Shrew frequency attack interval, frequency observation interval, and threshold value are set. In an embodiment, a device and/or application (e.g., at central repository 204) can obtain a spectrum in a Nyquist frequency range (e.g., from 0 Hz to 5 Hz) by applying a Discrete Fourier Transform (DFT) to the aggregated network traffic data.

In step 310 (explained in greater detail below), g statistics are calculated, the periodicity f is identified, and the location of the periodicity is tested (e.g., by a device and/or application at central repository 204). In an embodiment, the Fisher g-statistic test result can be obtained on Shrew detection based on periodical content detected on the frequency detection interval.

In step 312, at every location identified by periodicity f, a determination is made (e.g., by a device and/or application at central repository 204) regarding whether detected periodical frequency is outside or inside the Shrew frequency attack interval. If a determination is made that the detected periodical frequency is outside the Shrew frequency attack interval 314, a determination is made (e.g., by a device and/or application at central repository 204) that no Shrew attacks are contained within the aggregated data 316. If a determination is made that the detected periodical frequency is outside the Shrew frequency attack interval 318, the method proceeds to step 320.

In step 320, a Fisher g-test of significance is performed (e.g., by a device and/or application at central repository 204) to determine whether periodical content is significant 322 under the Fisher g-test of significance. For example, if the p-value is greater than the threshold value (e.g., p=10³), then a determination is made (e.g., by a device and/or application at central repository 204) that the periodical content is not significant enough to declare it a Shrew attack and that thus, no Shrew attacks are contained within the aggregated data 316. If the detected periodical content is in the Shrew frequency attack interval and it is significant (e.g., the p-value is less than the threshold value), then a determination is made (e.g., by a device and/or application at central repository 204) that the Fisher g-test has detected a potential Shrew attack and that the Fisher G-test should be performed.

In an embodiment, a positive result from Fisher g-test 206 (e.g., a determination that periodical content is significant 322 under the Fisher g-test of significance) can be enough to determine that a Shrew attack has occurred (e.g., without performing the Fisher G-test 208). For example, in an embodiment, the Fisher g-test 206 is enough to determine that a classic Shrew attack or a New Shrew attack has occurred. In an embodiment, if the Fisher g-test 206 confirms that a classic Shrew attack or a New Shrew attack has occurred, the result of the Fisher g-test 206 can be used to inform a device and/or application at central repository 204 that a Shrew attack has occurred so that action can be taken to mitigate the Shrew attack. In an embodiment, the Fisher g-test 206 is not enough to determine whether a distributed New Shrew attack has occurred (and a Fisher G-test 208 should be performed to confirm that a distributed New Shrew attack has occurred).

In an embodiment, for a Fisher G-test, Growing Hierarchical Self-Organizing Maps (GHSOM) clustering is applied to the aggregated data with the feature set [Source IP, (number of bytes÷number of packets)] to identify suspicious hosts. Optionally, time-series clustering can be used to isolated suspicious hosts. In an embodiment, individual network traffic data can be generated for hosts that were identified as suspicious. In an embodiment, for each individual network traffic data, the filtered spectrum is obtained in the Nyquist frequency range from 0 Hz to 5 Hz by applying a DFT, and the Fisher g-statistic test is applied to determine if there is a low-frequency periodic burst in the individual network traffic data. In an embodiment, if other system information (such as packet dropping information) is available, then it can be used as a precursor to trigger the proposed Shrew detection scheme.

In step 324 (explained in greater detail below), G statistics for the Fisher G-test are calculated, and the periodicity F is identified. In step 326, at every location identified by periodicity F, a determination is made (e.g., by a device and/or application at central repository 204) regarding whether detected periodical frequency is outside or inside the Shrew frequency attack interval. If a determination is made that the detected periodical frequency is outside the Shrew frequency attack interval 328, a determination is made (e.g., by a device and/or application at central repository 204) that no Shrew attacks are contained within the aggregated data 316. If a determination is made that the detected periodical frequency is inside the Shrew frequency attack interval 330, a determination is made (e.g., by a device and/or application at central repository 204) that a Fisher G-test of significance should be performed 332.

In step 334, if the periodicity F is significant, then a determination is made (e.g., by a device and/or application at central repository 204) that no Shrew attacks are contained within the aggregated data 316. If a determination is made (e.g., by a device and/or application at central repository 204) that the periodicity F is significant 332, then a determination is made that specific hosts are preforming Shrew attacks 336. In an embodiment, a notification can be sent (e.g., by a device and/or application at central repository 204 to a host controller and/or server) identifying the malicious hosts.

### 5. FISHER G-TEST AND FISHER G-TEST

The Fisher g-test and Fisher G-test will now be described in greater detail with reference to FIG. 3. In an embodiment, Fisher g-statistics are applied to one flow to detect the malicious activity in the system, while the Fisher G-statistics are applied to multiple flows to detect the Shrew attacker hosts. In an embodiment, both Fisher g and Fisher G statistics are based on the periodogram defined below:

$$\hat{S} ( f ) = \frac{Δ t}{N} {\vert {\sum }_{t = 1}^{N} X ( t ) {e}^{- j 2 π f t Δ t} \vert}^{2} \qquad ( 1 )$$

In an embodiment, for the spectral analysis, we assume the sampling time Δt, so periodicities are observed in the frequency domain in the double-sided frequency interval S_{N}=[−f_{N}, f_{N}], where f_{N}=1/(2Δt) is the Nyquist frequency. In an embodiment, the time series (aggregated network traffic from multiple hosts) denoted by X(t) containing N time points is converted in frequency domain via periodogram as in equation (1). In this way, in frequency domain by using equation (1), we can obtain m frequency points. In an embodiment, a user can set the Shrew frequency attack interval and the frequency observation interval (e.g., for substeps 1 and 2 of step 308 of FIG. 3).

In an embodiment, a threshold value (e.g., for substep 3 of step 308 of FIG. 3) can be set to decide if the detected periodicity is significant or not. In an embodiment, the threshold value can be set at th=10⁻³. In an embodiment, what we obtain from measurements of the aggregated network traffic from multiple hosts (e.g., by using the periodogram) is the Fisher g-statistic value given by equation (2) below calculated at each frequency point k, 1≤k≤m:

$$g = \frac{\hat{S} ( {f}_{k} )}{\hat{S} ( {f}_{1} ) + \hat{S} ( {f}_{2} ) + … + \hat{S} ( {f}_{m} )} \qquad ( 2 )$$

In an embodiment, the first step (denoted by a in step 310 of FIG. 3) of the Fisher g-test is to calculate the g-statistic given by equation (2). In an embodiment, the second step (denoted by b in step 310 of FIG. 3) is to identify the periodicity f, which is the index of:

$$g = \frac{{max}_{1 \leq k \leq m} \hat{S} ( {f}_{k} )}{\hat{S} ( {f}_{1} ) + \hat{S} ( {f}_{2} ) + … + \hat{S} ( {f}_{m} )} \qquad ( 3 )$$

In an embodiment, the third step (denoted by c in step 310 of FIG. 3) is testing the location of the periodicity.

In an embodiment, the result of calculating g gives information about the maximum element of the series x₁²x₂², . . . , x_{N}², where xᵢ=Σₜ₌₁^{N}Xₜe^{-j2πftΔt}. In this context, one does not need to normalize it by the sum of elements: x₁²+x₂²+ . . . +x_{N}². If there is an outlier in the sequence, then g helps that outlier to be more “visible” and to be more easily detected compared to the rest of the elements. In an embodiment, if the dynamic range of the series elements is small (i.e., all the elements have approximately the same value) then this g value will be also very small for all elements of the flow. In this case, the effect of g is to reduce the “visibility” of flow elements, which could sometimes be an advantage. Please note that, in an embodiment, these observations are true whether the series elements are random or deterministic.

In an embodiment, if we consider the quantity:

$$g = \frac{{x}_{i}^{2}}{{x}_{i}^{2} + {x}_{2}^{2} + … + {x}_{N}^{2}}$$

then this quantity can be interpreted as a probability if there exists a physical meaning associated with it. One can use the entropy to assess the dynamic range of the elements of the time series. If the dynamic range is small, then the entropy will get close to its maximum value when all elements are equal. In an embodiment, the sum x₁²+x₂²+ . . . +x_{N}² is the l₂ norm or the Euclidian distance of a vector containing that time series. In an embodiment, the root mean square (RMS) value of a collection of N elements is a statistical measure of the magnitude of a varying quantity defined as:

$${x}_{rms} = \sqrt{\frac{{x}_{i}^{2} + {x}_{2}^{2} + … + {x}_{N}^{2}}{N}}$$

which is also embedded in equation (2) or (3).

The decision block of step 312 (“f location?”) has two outputs. In an embodiment, if the detected periodicity is outside the Shrew frequency interval 314, then there is no suspicious activity detected. If there is a periodicity detected in the Shrew frequency interval 318, then the Fisher g-test of significance is applied 320 to decide if the detected periodicity is significant or not. In an embodiment, the Fisher g-test of significance 320 calculates the p-value for a realization of the g-statistics obtained in equation (3) with the following equation:

$$p = {\sum }_{j = 1}^{m} {( - 1 )}^{j - 1} ( \begin{matrix}m \\ j\end{matrix} ) {( 1 - jg )}^{m - 1} \qquad ( 4 )$$

In an embodiment, the decision block 322 (“is f significant?”) compares the p-value obtained from equation (4) with the threshold value which was set previously in the input block 308. In an embodiment, if the calculated p-value is greater or equal to the imposed threshold value (e.g., th=10⁻³), then there is NO malicious activity detected in system, and we will go to the input block 306, where the process of identifying the low and slow attacks will start again. In an embodiment, if the calculated p-value is less than the threshold value, then the output is YES, there is malicious activity detected in system, and we go to the next step 324 that uses the Fisher G-test.

In an embodiment, the Fisher G-test is active if there has been malicious activity detected in the system. In an embodiment, M time series from the system are applied as input to this test, all with the same number N of time points. In an embodiment, the first step in the Fisher G-test (denoted by A) in step 324) is to calculate the G-statistics as in equation (5) below:

$$G ≡ \frac{{max}_{1 \leq v \leq m} ‖ {S}_{v} ‖}{{\sum }_{v = 1}^{m} ‖ {S}_{v} ‖} \qquad ( 5 )$$

In an embodiment, equation (5) generalizes equation (3) from one time series (when M=1) by replacing the single periodogram elements of (1) by the Frobenious norm of the periodogram matrix Sᵥ as explained below.

In an embodiment, by using the periodogram of equation (1) applied to M time series from the system, we will transform the matrix realizations from time domain to spectral domain by obtaining a periodogram matrix S={Sᵥ(fᵥ)} of dimension M×m, 1≤u≤M, 1≤v≤m as follows. In an embodiment, each column Sᵥ(fᵥ) of the periodogram matrix S is calculated at Fourier frequencies

$${f}_{v} = \frac{2 π v}{N} , v = 1 , 2 , … , m = \frac{1}{2} ( N - 1 ) .$$

In an embodiment, by matrix Sᵥ=Sᵥ(fᵥ)Sᵥ(fᵥ)^{T}, we mean the periodogram matrix calculate at Fourier frequency fᵥ. In an embodiment, the Frobenious norm of the matrix Sᵥ is denoted by ∥Sᵥ∥V².

In an embodiment, the second step in the Fisher G-test (denoted by B in step 324) is to identify the periodicity F associated with the M time series from the system. In an embodiment, the periodicity F corresponds to the column index of the spectral matrix Sᵥ. In an embodiment, the third step in the Fisher G-test (denoted by C in step 324) is the testing of the location of the periodicity detected in a set of M time series.

The decision block 326 (“F location?”) has two outputs. In an embodiment, if the detected periodicity is outside the Shrew frequency interval, then there are no more attack hosts in the initial set of M time series, and the search for attack hosts is completed. In an embodiment, since there are no more attack hosts, we will go to the input 306 of the Fisher g-test by allowing a new aggregated network flow from multiple hosts (system) to be analyzed.

In an embodiment, if there is a periodicity detected (e.g., by using equation (5)) that is inside the Shrew frequency attack interval then, the Fisher G-test of significance is applied to decide if the detected periodicity F is significant or not. In an embodiment, the suspicious host is identified before applying the Fisher G-test of significance. In an embodiment, the suspicious host corresponds to the maximum element of the index column detected at step B of step 324. In an embodiment, the Fisher g-test of significance within the Fisher G-test 208 is the same one that was used in the Fisher g-test 206, and therefore we will keep the same threshold value th=10⁻³. In an embodiment, we will use the same p-value as in equation (4).

In an embodiment, the decision block 334 (“Is F significant?”) compares the p-value obtained from equation (4) with the threshold value (e.g., th=10⁻³) that was set previously in the input block 306. In an embodiment, if the calculated p-value is greater or equal to the threshold value, then there is no more malicious activity detected in system and we will go to the input block 306, where the process will start again. In an embodiment, if the calculated p-value is less than the threshold value, then the output is YES, and therefore the suspicious host is identified and removed from system containing M time series.

In an embodiment, after removing the identified attacker host, we will apply the Fisher G statistics to the remaining M−1 time series. In an embodiment, we will apply the Fisher G-statistics test for M−1 time series by using equation (5) and following the Fisher G-test algorithm 208 from FIG. 3. Please note that, in an embodiment, this time we need to modify equation (5) for the M−1 time series. In an embodiment, if there are M attack hosts in the system (only attacks), please note that for the last attack host, the Fisher G-test 208 became a Fisher g-test 206. In an embodiment, if there is a false alarm from Fisher g-test 206, then this is eliminated in the Fisher G-test 208 due to the Fisher g-test of significance, which is applied again.

### 6. SHREW ATTACK EXAMPLE

In an embodiment, there can be n normal hosts that are sending normal traffic to servers through a router. There can be k Shrew attack hosts that are sending Shrew attack traffic to servers through the same router. Shrew attack hosts may not always be active. Therefore, there can be time periods that all network traffic observed at the router consists of normal traffic during that time periods. Some attack hosts may work together to create distributed New Shrew attacks. Table 1 below shows results of a Fisher g-test of 5 samples of individual network traffic that comes from Shrew attack hosts:

TABLE 1
Fisher g Test of 5 Samples of Traffic From Shrew Attack Hosts

| | | | | | Fisher |
|---|---|---|---|---|---|
| Description of | | | | | g-test |
| Connections | F (Hz) | p-value | gF | g | Result |
| Host traffic 1 | 2.9933 | 0.3731 | 0.0069 | 0.0054 | Normal |
| Host traffic 2 | 3.5267 | 0.0665 | 0.0069 | 0.0067 | Normal |
| Host traffic 3 | 4.5700 | 0.1555 | 0.0069 | 0.0061 | Normal |
| Host traffic 4 | 0.3533 | 8.8767e−7 | 0.0069 | 0.0209 | Attack |
| Host traffic 5 | 0.5133 | 2.9137e−7 | 0.0069 | 0.0149 | Attack |

Table 2 below shows results of a Fisher G statistics test of different time series sets:

TABLE 2
Fisher G Test of Different Time Series Sets

| | | | | | Fisher |
|---|---|---|---|---|---|
| Description of | | | | | G-test |
| M time series | F (Hz) | p-value | | G | Result |
| Set #1, FIG. 1 | 0.4667 | 2.9137e−7 | 0.0042 | 0.0600 | Attack (5) |
| Set #2, FIG. 2 | 0.4000 | 8.8767e−7 | 0.0040 | 0.1297 | Attack (4) |
| Set #3, FIG. 3 | 3.4800 | 0.3731 | 0.0037 | 0.0114 | Normal |

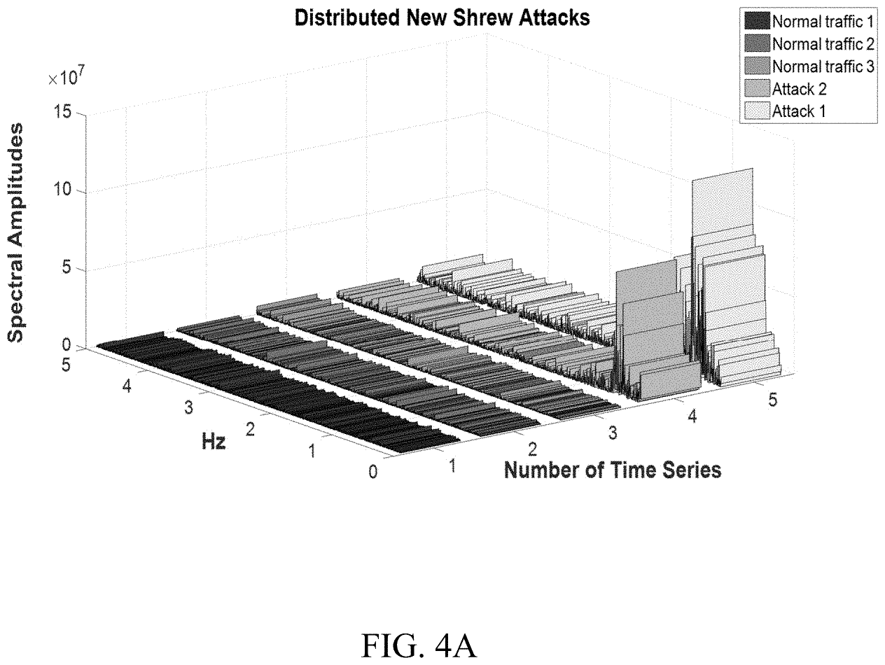

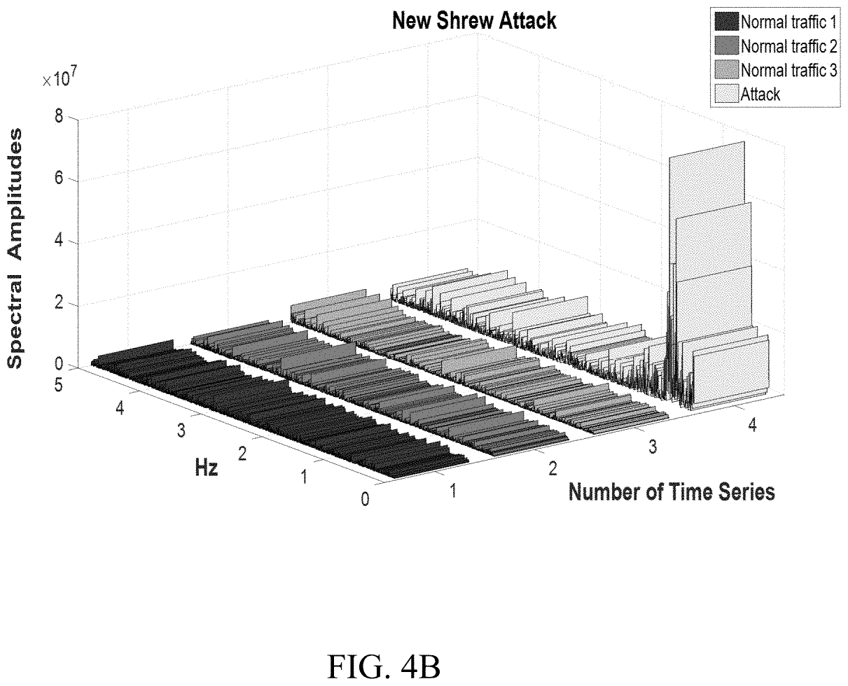

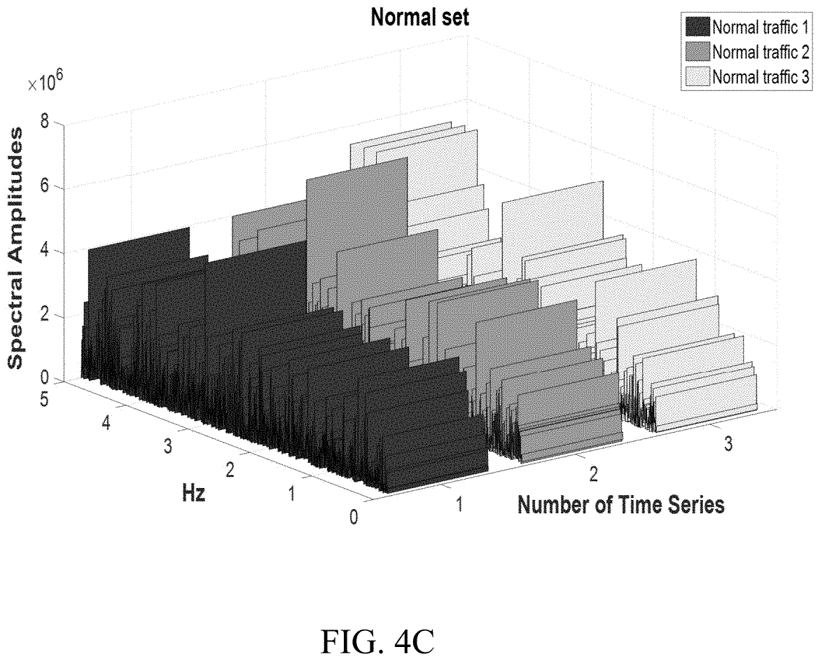

FIGS. 4A-4C show periodogram matrix representations of data from Table 1 and Table 2. For example, FIG. 4A shows a periodogram matrix representation of Set #1 containing 5 time series (rows 1, 2, 3, 4, and 5 from Table 1). In FIG. 4A, the first three time series are normal, while the forth and the fifth time series are Distributed Shrew Attacks. FIG. 4B shows a periodogram matrix representation of Set #2 containing time series (rows 1, 2, 3, and 4) from Table 1. Since there is only one attack (the fourth time series), the Fisher g-statistics and Fisher G-statistics will produce the same p value (please see row 4 from Table 1 and row 2 from Table 2). FIG. 4C shows a periodogram matrix representation of Set #3 containing only three time series (rows 1, 2, and 3 from Table 1). This is a normal set with no Shrew attacks.

In contrast to previous known approaches, systems and methods according to embodiments of the present disclosure are able to detect a potential Shrew attack in a network from one aggregate flow by applying a Fisher g-test. In an embodiment, there is no need to inspect an individual flow at every time interval. Once a Shrew attack is suspected from an aggregated flow, systems and methods according to embodiments of the present disclosure are able to detect source(s) of Shrew attack(s) from multiple flows by applying a Fisher G-test. In contrast to previous known approaches, which assume for the null hypothesis a Gaussian noise assumption, systems and methods according to embodiments of the present disclosure can apply a Fisher g-statistic test and Fisher G-statistic test for a small number of samples to detect the periodicity.

### 7. EXEMPLARY SYSTEM FOR DETECTING SHREW ATTACKS

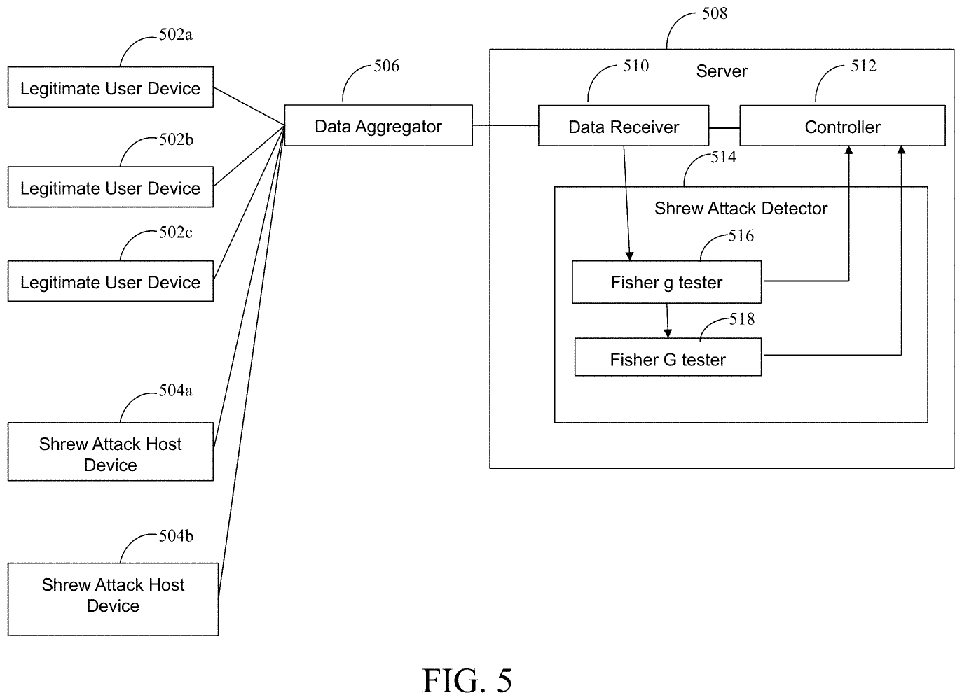

FIG. 5 is a diagram of an exemplary system for detecting Shrew attacks in accordance with an embodiment of the present disclosure. In FIG. 5, both legitimate user devices 502 and shrew attack host devices 504 can send data to a server 508 (e.g., via a data aggregator 506, such as a router). While data aggregator 506 is shown outside of server 508 in FIG. 5, it should be understood that, in an embodiment, data aggregator 506 can be located inside server 508 (e.g., as part of data receiver 510 in an embodiment).

In an embodiment, data aggregator 506 aggregates data from devices 502 and 504 and sends it to server 508, which can receive it via data receiver 510. In an embodiment, data receiver 510 can send (or, in an embodiment, be instructed to send by, e.g., controller 512) the aggregated data to shrew attack detector 514 for analysis. In an embodiment, Shrew attack detector 514 includes a Fisher g tester 516 and a Fisher G tester 518. Fisher g tester 516 and Fisher G tester 518 can be implemented using hardware, software, and/or a combination of hardware and software in accordance with embodiments of the present disclosure. Further, Fisher g tester 516 and Fisher G tester 518 can be implemented using a single device or multiple devices and as part of, or separate from the device(s) implementing server 508.

In an embodiment, Fisher g tester 516 performs an initial Fisher g-test on aggregated data from data receiver 510 (e.g., according to the steps described above with, for example, reference to FIGS. 2 and 3. In an embodiment, if Fisher g tester 516 does not detect a potential Shrew attack, Fisher g tester 516 can inform controller 512 that no potential Shrew attack has occurred. In an embodiment, if Fisher g tester 516 does detect a potential Shrew attack, Fisher g tester 516 can instruct Fisher G tester 518 to perform a Fisher G-test on the data and can optionally inform controller 512 that a potential Shrew attack has occurred.

In an embodiment, a positive result from Fisher g tester 516 (e.g., a determination that periodical content is significant 322 under the Fisher g-test of significance) can be enough to determine that a Shrew attack has occurred (e.g., without having to use Fisher G tester 518). In an embodiment, a positive result from Fisher g tester 516 is enough to determine that a classic Shrew attack or a New Shrew attack has occurred. In an embodiment, if Fisher g tester 516 confirms that a classic Shrew attack or a New Shrew attack has occurred, Fisher g tester 516 can inform controller 512 that a Shrew attack has occurred so that action can be taken to mitigate the Shrew attack. In an embodiment, Fisher g tester 516 cannot determine whether a distributed New Shrew attack has occurred (and Fisher G tester 518 should be used to confirm that a distributed New Shrew attack has occurred).

In an embodiment, if Fisher G tester receives a notification from Fisher g tester 516 that a potential Shrew attack has occurred, Fisher G tester 518 performs a Fisher G-test on the data (e.g., according to the steps described above with, for example, reference to FIGS. 2 and 3). If Fisher G tester 518 does not detect a potential Shrew attack (e.g., if Fisher G tester 518 determines that Fisher g tester 516 has detected a “false alarm”), Fisher G tester 518 can inform controller 512 that no potential Shrew attack has occurred. In an embodiment, if Fisher G tester 518 does detect a potential Shrew attack, Fisher G tester 518 can inform controller 512 that one or more Shrew attack(s) have occurred and can send an identification of the malicious host(s) 504 to controller 512. In an embodiment, controller 512 can take action to mitigate the shrew attacks from shrew attack host devices 504 (e.g., by denying permission to shrew attack host devices 504 to send data to server 508). In an embodiment, controller 512 can send information to data aggregator 506 so that data aggregator 506 can take action to mitigate the shrew attacks from shrew attack host devices 504 (e.g., by denying permission to shrew attack host devices 504 to send data to data aggregator 506).

Server 508, data aggregator 506, and/or components of server 508 and data aggregator 506 can be implemented using hardware, software and/or a combination of hardware and software in accordance with embodiments of the present disclosure. Server 508, data aggregator 506, and/or components of server 508 and data aggregator 506 can be implemented using a single device or multiple devices in accordance with embodiments of the present disclosure. In an embodiment, shrew attack detector 514 is implemented on a separate device from server 508 (e.g., as a special purpose device for detecting and isolating shrew attacks).

In an embodiment, server 508 is a special purpose device for detecting shrew attacks, and shrew attack detector 514 is an application executing on special purpose server 508. For example, in an embodiment, server 508 is a special purpose device that detects and isolates sources of shrew attacks before data is sent to another server for further processing. In an embodiment, shrew attack detector is special purpose hardware installed on a device to detect and isolate shrew attacks. In an embodiment, server 508 is a general purpose device (e.g., a general purpose server), and shrew attack detector is a special purpose application executing on server 508 to detect and isolate shrew attacks.

### 8. EXEMPLARY ADVANTAGES

Embodiments of the present disclosure advantageously exploit the periodicity in the frequency domain. Embodiments of the present disclosure present an original Shrew detection scheme detecting periodicities in spectral domain using Fisher g-tests and Fisher G-tests of time series to detect the offending hosts. Embodiments of the present disclosure can first determine if there is a malicious activity or not based on aggregated network traffic from multiple hosts by using a Fisher g-test. In an embodiment, if there is a suspicion that there may be a Shrew attack, then embodiments of the present disclosure can identify a set of potential attack host(s) by using a Fisher G-test. Embodiments of the present disclosure can then identify Shrew attack host(s) by testing periodic network traffic content from individual suspected host by using a Fisher g statistic test.

Embodiments of the present disclosure include systems and methods for applying a Fisher g and Fisher G-test to a periodogram matrix to find the periodic content of any set of “aggregate” traffic flow from multiple hosts. This allows the experimental testing of the null hypothesis H₀ where no periodicity (periodic content, quasi periodicity) is assumed, against the alternative hypothesis H₁ when such periodicities exist. In other words, in the Fisher G statistic, we are able to test the null hypothesis H₀ that the spectral peak is statistically insignificant against the alternative hypothesis H₁ that there is a significant periodic component in the “aggregate” flow.

In an embodiment, we generalized the Fisher g statistic focusing on the null hypothesis when it is assumed that no periodicity (no attack) exists. Embodiments of the present disclosure include a new methodology based on Fisher g-test to detect low frequency periodic bursts from Shrew and New Shrews attacks. In an embodiment, if there is suspicion of low frequency periodic bursts, then the Fisher G-test is used to isolate offending hosts that show low frequency periodic bursty behavior.

In contrast with conventional approaches which assume for null hypothesis the Gaussian noise assumption, embodiments of the present disclosure can estimate the variance (standard deviation) directly from the time series by using sample variance. Embodiments of the present disclosure make no assumption about the time duration of the periodic content embedded in the time series. In contrast with systems that assume that the attack is “continuously” in effect until the buffer is full, embodiments of the present disclosure can detect a malicious flow even when the attack is “bursty” in nature. Embodiments of the present disclosure do not assume that when the number of samples is large, we can apply the central limit theorem to approximate the aggregate flow by a Gaussian random variable. Due to the low overhead (i.e., does not have to test traffic from individual hosts for presence of a Shrew attack), the embodiments of the present disclosure can be routinely deployed.

### 9. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented as a computer program executing on a machine, as a computer program product, or as a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

1. A device, comprising:
a Shrew attack detector, comprising:
a Fisher g tester configured to determine whether a Shrew attack has potentially occurred in aggregated data received by the device, and
a Fisher G tester configured to:
determine, based on a result from the Fisher g tester, whether the Shrew attack has occurred in the aggregated data, and
identify a Shrew attack host in response to determining that the Shrew attack has occurred in the aggregated data; and
a controller device configured to:
receive an identification of the Shrew attack host from the Fisher G tester, and
mitigate the Shrew attack.

2. The device of claim 1, wherein the Fisher G tester is further configured to:
identify a plurality of Shrew attack hosts in response to determining that the Shrew attack has occurred.

3. The device of claim 2, wherein the controller is further configured to:
receive a plurality of identifications corresponding to the plurality of Shrew attack hosts from the Fisher G tester, and
mitigate corresponding Shrew attacks from the plurality of Shrew attack hosts.

4. The device of claim 1, wherein the Fisher g tester is configured to determine that the Shrew attack is a classic Shrew attack.

5. The device of claim 1, wherein the Fisher g tester is configured to determine that the Shrew attack is a New Shrew attack.

6. The device of claim 1, wherein the Fisher G tester is configured to determine that the Shrew attack is a distributed New Shrew attack.

7. The device of claim 1, wherein the controller is configured to mitigate the Shrew attack by blocking access of the Shrew attack host to the device.

8. The device of claim 1, wherein the controller is configured to send a message to a data aggregator identifying the Shrew attack host in response to receiving the identification of the Shrew attack host.

9. The device of claim 1, wherein the Fisher g tester is further configured to send a message to the controller notifying the controller that no Shrew attack has occurred in the aggregated data in response to determining that the Shrew attack has not occurred in the aggregated data.

10. The device of claim 1, wherein the Fisher G tester is further configured to send a message to the controller notifying the controller that the Fisher g tester has detected a false alarm in response to determining that the Shrew attack has not occurred in the aggregated data.

11. The device of claim 1, wherein the Fisher g tester is further configured to:
determine whether a detected Fisher g periodicity in the aggregated data is inside a Shrew frequency attack interval.

12. The device of claim 11, wherein the Fisher g tester is further configured to:
perform a Fisher g-test of significance on the aggregated data in response to determining that the detected Fisher g periodicity in the aggregated data is inside the Shrew frequency attack interval.

13. The device of claim 12, wherein the Fisher g tester is configured to determine that the Shrew attack has potentially occurred in the aggregated data in response to determining that the Fisher g-test of significance indicates that detected Fisher g periodical content in the Shrew frequency attack interval is significant.

14. The device of claim 1, wherein the Fisher G tester is further configured to:
determine whether a detected Fisher G periodicity in the aggregated data is inside a Shrew frequency attack interval.

15. The device of claim 14, wherein the Fisher G tester is further configured to:
perform a Fisher G-test of significance on the aggregated data in response to determining that the detected Fisher G periodicity in the aggregated data is inside the Shrew frequency attack interval.

16. The device of claim 14, wherein the Fisher G tester is further configured to:
determine that the Shrew attack has occurred in the aggregated data in response to determining that the Fisher G-test of significance indicates that detected Fisher G periodical content in the Shrew frequency attack interval is significant.

17. A Shrew attack detector, comprising:
a Fisher g tester configured to:
determine, using a controller device, whether a detected Fisher g periodicity in aggregated data received by the Shrew attack detector is inside a Shrew frequency attack interval,
perform, using the controller device, a Fisher g-test of significance on the aggregated data in response to determining that the detected Fisher g periodicity is inside the Shrew frequency attack interval, and
determine, using the controller device, whether a Shrew attack has potentially occurred in aggregated data received by the device based on a result from the Fisher g-test of significance; and
a Fisher G tester configured to:
determine, using the controller device and in response to a determination that the Fisher g tester has determined that the Shrew attack has potentially occurred in the aggregated data, whether a detected Fisher G periodicity in the aggregated data is inside the Shrew frequency attack interval,
perform, using the controller device, a Fisher G-test of significance on the aggregated data in response to determining that the detected Fisher G periodicity in the aggregated data is inside the Shrew frequency attack interval, and
determine, using the controller device and based on a result from the Fisher G-test of significance, whether the Shrew attack has occurred in the aggregated data.

18. A method, comprising:
determining, using a processing device of a device, whether a Shrew attack has potentially occurred in aggregated data received by the device based on a first result from a Fisher g-test on the aggregated data;
determining, using the processing device and based on the result from the Fisher g-test, whether the Shrew attack has occurred in the aggregated data based on a second result from a Fisher G-test on the aggregated data; and
identifying, using the processing device, a Shrew attack host in response to determining that the Fisher G-test indicates that the Shrew attack has occurred in the aggregated data.

19. The method of claim 18, further comprising:
determining whether a detected Fisher g periodicity in the aggregated data is inside a Shrew frequency attack interval;
performing a Fisher g-test of significance on the aggregated data in response to determining that the detected Fisher g periodicity is inside the Shrew frequency attack interval; and
determining whether the Fisher g-test indicates that the Shrew attack has potentially occurred in the aggregated data based on a third result from the Fisher g-test of significance.

20. The method of claim 18, further comprising:
determining, in response to a determination that the Fisher g-test indicates that the Shrew attack has potentially occurred in the aggregated data, whether a detected Fisher G periodicity in the aggregated data is inside the Shrew frequency attack interval;
performing a Fisher G-test of significance on the aggregated data in response to determining that the detected Fisher G periodicity in the aggregated data is inside the Shrew frequency attack interval; and
determining, based on a third result from the Fisher G-test of significance, whether the Fisher G-test indicates that Shrew attack has occurred in the aggregated data.
